(19) United States
(12) Patent Application Publication
(10) Pub. No.: US 2018/0326711 A1
(43) Pub. Date: Nov. 15, 2018

(54) DEVICE FOR STORAGE OF MODULAR FUNCTIONAL UNITS

(71) Applicant: CL SCHUTZRECHTSVERWALTUNGS GMBH, Lichtenfels (DE)

(72) Inventor: Frank HERZOG, Lichtenfels (DE)

(73) Assignee: CL SCHUTZRECHTSVERWALTUNGS GMBH, lichtenfels (DE)

(21) Appl. No.: 15/771,674

(22) PCT Filed: Nov. 10, 2016
(86) PCT No.: PCT/EP2016/077228

§ 371 Date: Apr. 27, 2018

(30) Foreign Application Priority Data
Nov. 13, 2015 (DE) 10 2015 119 698.0

(51) Int. Cl. B33Y 40/00; B33Y 30/00; B22F 3/105

(52) U.S. Cl. CPC B33Y 40/00; B22F 3/24; B22F 3/1055; B33Y 30/00

(57) ABSTRACT

A device (1) for storage modular functional units (2) to be used in the context of the generative production of three-dimensional objects, comprising—a storage device (7) including several storage partitions (9) which are configured for storage of at least one functional unit (2) and—a handling device (8) assignable or assigned to the storage device (7) for the handling of at least one modular functional unit (2), which is configured for application of at least one modular functional unit (2) in a given storage partition (9) and/or for removal of at least one modular functional unit (2) in a given storage partition (9) from this or any other storage partition (9).

### CROSS-REFERENCE TO RELATED APPLICATIONS

This application is a United States national stage entry of an International Application serial no. PCT/EP2016/077228 filed Nov. 10, 2016 which claims priority to German Patent Application serial no. 10 2015 119 698.0 filed Nov. 13, 2015. The contents of these applications are incorporated herein by reference in their entirety as if set forth verbatim.

### DESCRIPTION

The invention concerns a device for storage of modular functional units to be used in the context of the generative production of three-dimensional objects.

The use of modular functional units is known in the context of the implementation of generative construction processes for the generative manufacture of three-dimensional objects. Corresponding functional units assume one or more object(s) or function(s) for a generative construction process. One example of such a modular functional element is a construction module which comprises a movable (particularly a height-adjustable) building board or base plate which is positioned relative to a base body of the construction module, on which generative composition of a three-dimensional object is carried out.

Corresponding modular functional units are separately manipulable—that is, in particular, independently of a device for carrying out generative construction processes—and can (temporarily) be stored separately. For (temporary) storage of corresponding functional units, storage devices are known in which corresponding functional units corresponding functional devices can be stored (temporarily).

There is a need for further development of corresponding storage devices with respect to the simple and dependable storage and handling of corresponding functional units.

The object of the invention thus concerns an improved device for storage of modular functional units used or to be used in the context of the generative production of three-dimensional objects.

The object is fulfilled by a device according to the claims. The appurtenant dependent claims concern possible forms of embodiment of the device.

The device described here concerns storage, particular temporary storage, of modular functional units to be used in the context of the generative production of three-dimensional objects. The device can in this respect be considered or deemed to be a storage device.

A coherent assembly constructed modularly, especially in a cuboid geometrical form, can be considered to be a functional unit, which takes over certain tasks or functions in the process of the generative manufacture of three-dimensional objects. The modular composition of a corresponding functional unit enables separate handling of the functional unit. This is in particular to be understood as the handling of the functional unit independently of other components of the storage device—in combination with the storage device with a facility for the generative manufacture of three-dimensional objects—respectively handling the functional unit independently of diverse components of such a facility, i.e. especially of a device for the generative manufacture of three-dimensional objects.

Three possible embodiments of corresponding functional units will be presented in the following. The following list is not exhaustive:

According to a first exemplary embodiment a functional unit can be formed as a construction module. A construction module of this type comprises as a minimum a movable (particularly a height-adjustable) building board or base plate which is positioned relative to a base body of the construction module, on which generative composition of at least one three-dimensional object can be carried out. In the context of the generative manufacture of three-dimensional objects, a construction module serves as storage for a generatively manufactured three-dimensional object during the implementation of a generative construction process.

According to a second exemplary embodiment a functional unit can be formed as a dosing module. Such a dosing module comprises at least one typically chamber-like recording space configured for receiving construction material to be solidified in the generative manufacture of a three-dimensional object and, in a given case, a dosing device for dosing a given amount of construction material from the receiving space for the generative manufacture of a three-dimensional object. A dosing module serves—in the context of the generative manufacture of three-dimensional objects—particularly to prepare (dose) a given amount of construction material to be solidified, which is distributed by means of a coating device for the formation of a defined layer of construction material evenly across a construction surface of a device for the generative manufacture of three-dimensional objects.

According to a third exemplary embodiment a functional unit can be formed as an overflow module. Such an overflow module comprises at least one typically chamber-like recording space configured for the generative manufacture of a three-dimensional object of not solidified construction material. In the context of the generative manufacture of three-dimensional objects, the overflow module particularly serves to accept non-solidified construction material that should be removed or has been removed from a construction or processing chamber of a device for generative manufacture.

Construction material is preferably a metal powder, i.e. for example a powder of aluminum or an aluminum alloy, a powder of an iron alloy (steel), a powder of titanium, or a titanium alloy, etc. It is, however, possible that the construction material may be a plastic powder, i.e. a powder of polyethylene phthalate (PET) or a ceramic powder, i.e. a powder of aluminum oxide.

The storage device comprises as central constituents at least one storage facility and at least one handling facility assignable or assigned to the storage device.

The storage device serves as the actual storage location of corresponding functional units. The storage device comprises storage sections which are configured for storage of at least one functional unit. A storage space for storage of at least one corresponding functional unit is spatially limited by a respective storage partition.

The storage device can comprise a shelf-like construction with storage partitions arranged in different rows and/or columns. A given number and arrangement corresponding to storage partitions arranged in rows and/or columns can form a shelf element. Several corresponding shelf elements can be placed in a given arrangement next to and/or over each other in order to form the storage device in the most compact way and utilize the storage or memory capacity in the most optimal way. Several shelf units can be arranged, for example, curving along a circular arc next to each other.

Individual, several, or all storage sections can be defined spatially by walls. Corresponding walls are, in particular, horizontally or vertically directed or running walls. At least one wall can in at least one degree of freedom be displaceable—that is, in particular, slidable—relative to at least one further wall, so that a storage partition can be changed in its spatial dimensions by the at least one displaceable wall and the storage section limited spatially by at least one further wall through movement of the minimum one displaceable wall relative to a further wall. The variability of the storage device can be increased in this way. A further possibility is added to utilize the storage or memory capacity of the storage device most optimally.

The handling device allows for the handling of individual or several functional units. The handling devices can accordingly be made partially or fully automatic or partially or fully automated for the handling of at least one functional unit. The handling of corresponding functional units comprises deploying or placing and directing at least one functional unit in a given storage partition and/or removal of at least one functional unit assigned to a given storage partition from the, or generally one, given storage partition.

The handling devices may either consist entirely of a gripping device with at least one handling or gripping component therein, or at least comprise such a gripping device. A corresponding gripping component is typically movable in at least one degree of freedom. The freedom degrees of a gripping component can be translatory and/or rotational freedom degrees. Combined movements of a gripping component are in principle possible in at least two freedom degrees, i.e. combined translatory and rotational movements.

Specifically, a gripping device can comprise a gripping component for lifting, which moves along a first, typically vertical, axis of movement (translation axis). The gripping component can be mounted in at least one further, typically horizontal, axis of movement (translation axis). A corresponding gripping device can in principle be implemented as a robot (industrial robot). Such a robot typically comprises several robot arms displaceable in at least one degree of freedom. At least one robot arm comprises at least one gripper component displaceably-mounted in at least one degree of freedom of movement.

The entire handling device can (also) in principle be mounted with at least one degree of freedom (relative to the storage device). The handling device can alternatively also be mounted to be stationary, i.e. not displaceable relative to the storage device.

A possible further development of the storage device is to allow for a recording device to be associated, or to proceed to associate such a recording device, with at least one storage partition. A recording device typically comprises at least one recording element implemented by hardware and/or software. By means of a recording device equipped with a recording element through the use of suitable hardware and/or software, different recording parameters can be recorded, which clearly increases the functionality and practical usability of the storage device. All recording parameters recorded by a corresponding recording device can be transmitted via a possibly wireless data or communications network to at least one communications partner, i.e. a central control device of a facility for the generative manufacture of three-dimensional objects.

The or a recording device can, for example, be configured to record a functional unit in the storage partition in question. It can be determined via a correspondingly configured recording device whether a functional unit is stored in a given storage partition. In the case of a functional unit in a given storage partition, it can further be recorded what specific kind of functional unit it is. How much storage capacity on the storage device is free or occupied can accordingly be recorded along with which functional unit(s) are in which storage partitions. The recording of a functional unit's type within a given storage partition can, for example, be carried out either optically—that is, particularly by means of an optical scanner process—or mechanically, that is, particularly by means of recording the weight of the functional unit acting on the storage device.

The or a (further) recording device can, for example, (also) be configured for the recording of at least one status parameter, particularly the functionality, of at least one functional element of a functional unit located in the storage partition in question. Certain status parameters—that is, particularly, the functionality—of given functional elements are ascertainable by means of a correspondingly configured recording device. In the case of a construction module it is, for example, ascertainable whether the proper functionality of the displaceably-mounted construction board is correct. The recording device can, for example, transmit appropriate control information to a drive connected to the displaceably-mounted construction board and, for example, carry out a local and/or timed recording (monitoring) of a movement of the construction board under the given actuator conditions by means of the control information. The recorded movement of the construction board allows for conclusions regarding the functional capability of the movable mounting of the construction board.

The or a further recording device can, for example, (also) be configured for the recording of at least one, especially physical, status parameter of a functional unit located in the relevant storage partition, within a recording space that is at least filled out in sections with construction material. Given—that is, especially, physical—status parameters, i.e. atmosphere, pressure, humidity, temperature, etc., are ascertainable within recording rooms which track functional units via a correspondingly configured recording device. In the case of a dosing or overflow module the atmosphere, pressure, humidity, temperature, etc. within the given recording space can be recorded. The recorded status parameters inside a recording space enable conclusions regarding the quality or processability or reusability of the construction material in the functions unit. The recording of corresponding status parameters can be done by means of appropriate recording elements that are configured as a probe which record corresponding conditional parameters via an interface provided for this purpose. A functional interface on the side of the unit can, for example, be realized by means of an access point on and/or in a recording space for functional units.

The or a further recording device can, for example, (also) be configured for the recording of the fill level of a construction material, which is configured in a recording space of a functional unit in the storage partition. Fill levels of a construction material located in a recording space for functional units of an existing construction material are ascertainable via a correspondingly configured recording device. The fill level within the recording space is ascertainable in the case of a dosing or overflow module. The recorded fill levels enable conclusions as to the necessity of filling or emptying the dosing or overflow module. The recording of corresponding fill levels can be carried out by means of appropriate recording elements that are configured as a probe which record corresponding fill levels via an interface provided for this purpose. An interface for functional units can also, for example, be realized here by means of an access point on and/or in a recording space for functional units.

Finally, the or a further recording device can, for example, (also) be configured for the recording of one, particularly physical, status parameter of a construction material, which is configured in a recording space of a functional unit in the storage partition. By means of a correspondingly configured recording device, therefore, generally determined, that is, especially, physical, status parameters including atmosphere, pressure, humidity, temperature, etc., are ascertainable within recording spaces by tracking functional units of construction material inside a functioning recording space. In the case of a dosing or overflow module, density, humidity, temperature, etc. are recorded for a construction material. The recorded status parameters inside a recording space enable conclusions regarding the quality or processability or reusability of the construction material in the functional unit. The recording of corresponding status parameters can be done by appropriate means, for example recorded elements from measuring probes, which record corresponding conditional parameters via an interface provided for this purpose. A functional interface on the side of the unit can, for example, be realized by means of an access point on and/or in a recording space for functional units.

In view of recordable recording parameters via correspondingly configured recording devices, the storage device can comprise certain further devices or at least be connected with them with respect to data, by means of which certain measures can be taken depending on the acquisition parameters, in order, for example, to influence the quality, processability or capacity for reuse of the construction material located in a functional unit of a recording space.

For example, a tempering device can be assignable or assigned to at least one storage partition that is configured for tempering at least one recording space of a functional unit and is configured in the given recording space filled with construction material, specifically at least in sections and/or for tempering a construction material that is in a recording space of a functional unit of the storage partition. Tempering, which is typically understood to be heating, can, for example, be carried out by (direct) tempering of the functional unit and/or by a control (activation) of a functional unit of designated tempering agents, for example, heating elements. The tempering device for tempering the functional unit can introduce a correspondingly tempered temper fluid by means of a suitable connection device or interface, for example, in a functional unit of a tempering channel structure. For the control (activation) of tempering agents provided at the functional unit, the tempering device can transmit control data via a suitable connection device or interface, whereby a simple electric supply is understood, to the respective tempering agents of the functional unit.

Furthermore, an inerting device can be assignable or assigned to at least one storage partition that is configured for inerting at least one recording space of a functional unit in the given recording space filled with construction material. The inerting device for inerting a recording space can via suitable means of connection or interfaces and exhaust devices connectable or connected to them exhaust non-inert gases or gas mixtures, such as air, from the recording space and/or introduce with these connectable or connected fan devices inert gases or gas mixtures such as argon, CO2, nitrogen, etc. into the recording space.

Furthermore, a filling device can be assignable or assigned to at least one storage partition that is configured for the filling of at least one recording space of a functional unit configured in the given recording space filled with construction material and/or an emptying device that is attachable or can be attached that is configured for emptying construction material located in at least one recording space of a functional unit in the storage partition in question. For the filling of a recording space, for example a recording space of a dosing module, a filling device can introduce construction material into the recording space via a filling device through suitable means of connection or interfaces with these connectable or connected handling devices. For emptying a recording space, for example a recording space of an overflow module, an emptying device can siphon construction material from the recording space by means of suitable connections or interfaces with these connectable or connected suction devices.

A security device can be assignable or assigned to at least one storage partition that is installed to be fixed in place for a functional unit installed in a storage partition. A corresponding security device enables fixed and stable mounting of a storage device of a functional unit installed in a storage partition and thus increases the security of the storage device. The security device can comprise at least one especially mechanical and/or magnetic security element, for example in the form of a mechanical pin, projection, etc. or of a magnetizable or magnetic magnet element, which acts in a security circumstance on the functional unit to be secured so that the functional unit is installed fixed to its position in the storage partition. Corresponding—especially mechanical or magnetic—countersecurity elements, for example by receiving security pins or magnetizable or magnetic magnet elements, can, of course, be provided.

The storage device can comprise at least one of the above-named devices, i.e. a tempering device, an inerting device, a filling device, an emptying device, or a security device for control of the operation. The control device is especially configured to control the operation of individual, several, or all of the named devices. The control can be carried out on the basis of at least one recording parameter recorded by means of a recording device. Control of the operation of a tempering device dependent on a recorded temperature can, for example, be carried out in order to temper the construction material accordingly. In a corresponding manner, control of an operation, for example of an inerting device dependent on recorded atmosphere and/or recorded pressure within a recording space, can be carried out in order to inertize the recording space.

The invention further concerns a facility for the generative manufacture of three-dimensional objects. The facility comprises at least one, possibly multiple, storage device(s) from modular functional units used in the generative manufacture of three-dimensional objects such as at least one—that is, for example, in a given case, multiple—device(s) for the generative manufacture of three-dimensional objects through successive layered selective solidification of construction material layers from solidifiable construction material by means of at least one energy or laser beam. The latter devices comprise at least one device for generation of at least one energy or laser beam for layered selective solidification of individual construction material layers from solidifiable construction material. For the latter devices, it may be a matter of selective laser melt devices (SLM devices) or selective laser sinter devices (SLS devices). All embodiments in connection with the storage device are valid analogously for the facility.

As regards the arrangement or integration of the storage device within the facility, it is possible that at least one device for storage of the modular functional units of at least one device for the generative manufacture of three-dimensional objects concerns a device for storage of modular functional units to be used in the context of the generative production of three-dimensional objects. A storage device can be assigned, for example, to a preparation station (handling station) for preparation of a generative construction process or to a reprocessing station (handling or unpacking station) for post-processing a generative construction process, that is, especially, for “unpacking” a generatively manufactured three-dimensional object.

To the extent that the facility comprises several separate storage devices, transport devices—that is, for example, in a given case, inertable tunnel-like transport or rail systems—can be provided in order to transport functional units back and forth between separated storage devices.

The invention is explained in more detail in the exemplary embodiments in the drawings. The following are shown:

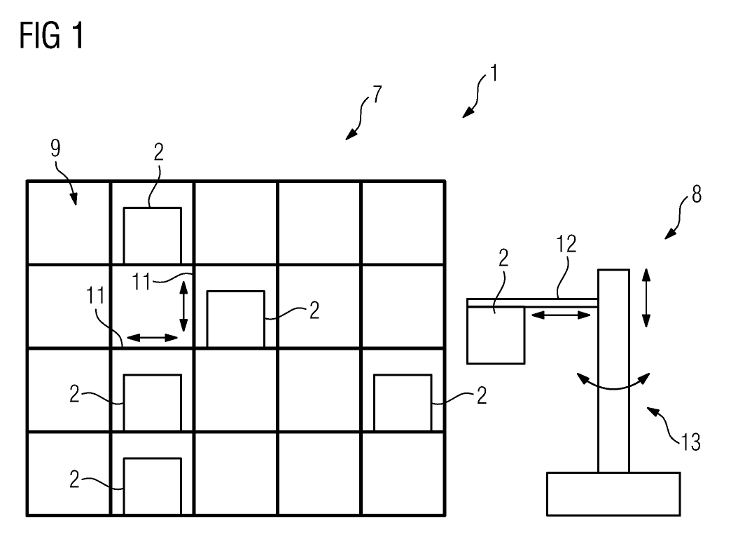

FIG. 1-3 a schematic diagram of a storage device for storing modular functional units and

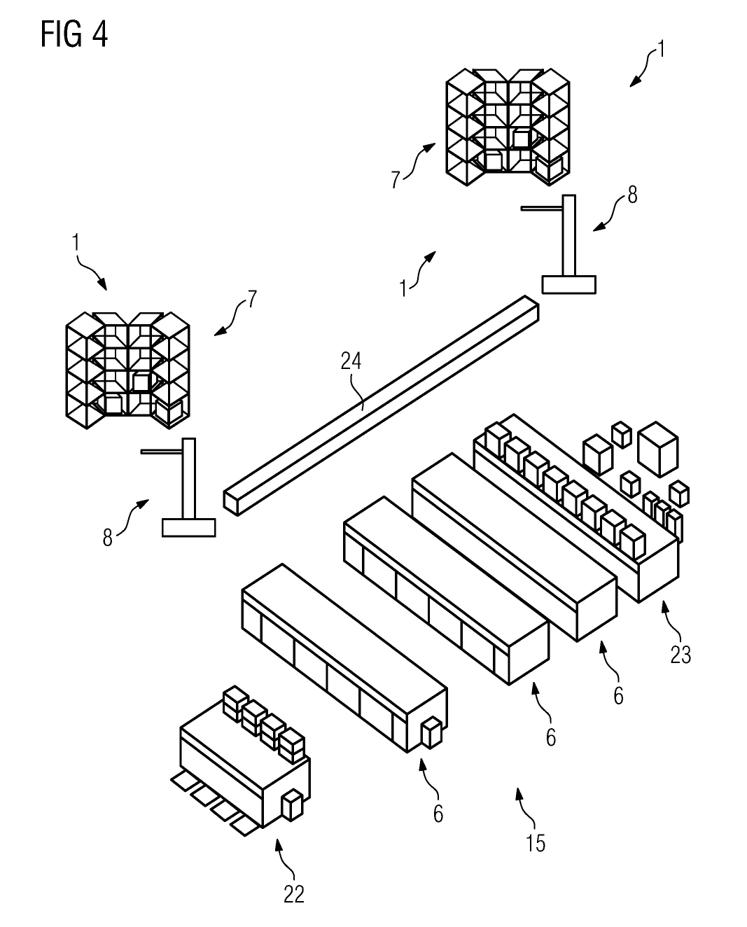

FIG. 4 a schematic diagram of a facility comprising such a storage device for the generative manufacture of three-dimensional objects.

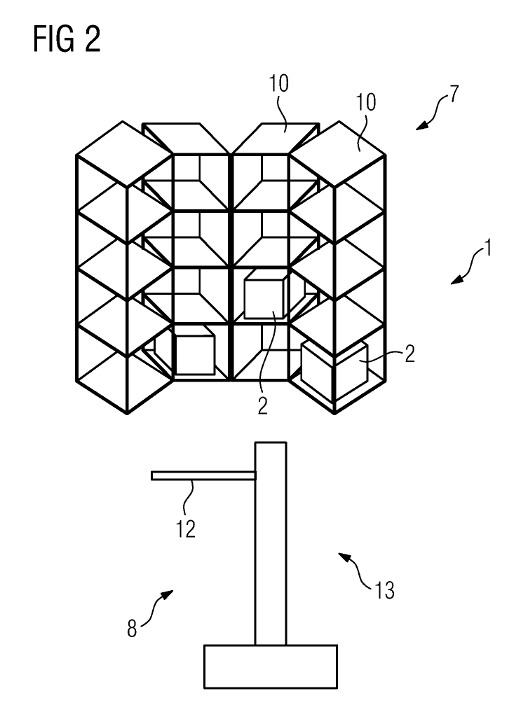

In FIG. 1-2 a schematic diagram of a storage device 1 for storing modular functional units 2 is shown. Storage device 1 concerns storage—that is, particularly, temporary storage—of modular, typically cubical, functional units 2 for use in the generative manufacture of three-dimensional objects.

Functional unit 2 can, for example, be a construction module 2a. A construction module 2a comprises a building board 3 that is movable, specifically height-adjustable, relative to a base body of the construction module 2a (cf. FIG. 2) on which generative construction of a three-dimensional object can carried out. In the context of the generative manufacture of three-dimensional objects, a construction module 2a serves as storage for a generatively manufactured three-dimensional object during the implementation of a generative construction process.

Functional unit 2 can, for example, be a dosing module 2b. A dosing module 2b comprises at least one typically chamber-like recording space 5 configured for the recording of construction material 4 to be solidified in the generative manufacture of a three-dimensional object and, in a given case, a dosing device (not shown) for dosing a given amount of construction material 4 from the recording space 5 for the generative manufacture of a three-dimensional object. A dosing module 2b serves in the context of the generative manufacture of three-dimensional objects, particularly in preparation (dosing) a given amount of construction material 4 to be solidified, which is distributed by means of a coating device for formation of a defined layer of construction material evenly across a construction surface of a device 6 for the generative manufacture of three-dimensional objects.

Functional unit 2 can further be an overflow module 2c. An overflow module 2c comprises a typically chamber-like recording space 5 configured for the recording of the generative manufacture of a three-dimensional object of non-solidified construction material 4. In the context of the generative manufacture of three-dimensional objects, the overflow module 2c particularly serves to accept non-solidified construction material 4 that should be removed or has been removed from a construction or processing chamber of a device 1 for generative manufacture.

The storage device 1 comprises as a central constituent at least one storage facility 7 and at least one handling facility 8 assignable or assigned to the storage device 7.

The storage device 7 acts as the actual storage of corresponding functional units 2. For this purpose, the storage device comprises several storage partitions 9 which are configured for storage of at least one functional unit 2.

It can be seen from FIG. 1, 2 that storage device 7 can comprise a shelf-like construction with storage partitions 9 arranged in different rows and/or columns. A given number and arrangement corresponding to storage partitions 9 arranged in rows and/or columns can form a shelf element 10. Several corresponding shelf elements 10 can be placed in a given arrangement next to and/or over each other in order to form the storage device 7 in the most compact way and to utilize the storage or data capacity of storage device 7 in the most optimal way. Several shelf units 10 can be arranged curving along a circular arc next to each other (cf. FIG. 2).

The respective storage partitions 9 are spatially defined by walls 11. In the exemplary embodiments shown in the Fig. corresponding walls 11 are oriented or run horizontally or vertically. Individual, several, or all walls 11 can—as in FIG. 1 indicated by the double arrow in storage device 7—be displaceable in at least one degree of freedom, that is, in particular, be slidable relative to at least a further wall 11, so that a spatially limited storage partition 9 can be changed in its spatial dimensions by means of a displaceable wall 11 and by a further wall 11 through movement of a displaceable wall 11 relative to a further wall 11. The variability of the storage device 7 can be increased in this way. A further possibility is added to utilize the storage or memory capacity of the storage device 7 as optimally as possible.

The handling device 8 serves to handle individual or several functional units 2 and is correspondingly partially or fully automatable or partially or fully automated for the handling of at least one functional unit 2. The handling of corresponding functional units 2 comprises deploying or placing and directing at least one functional unit 2 in a given storage partition 9 and/or removal of at least one functional unit 2 assigned to a given storage partition 9 from the, or generally, one given storage partition 9.

In the exemplary embodiments shown in FIG. 1,2 the handling device 8 is configured as a handling or gripping device 13 comprising gripping component 12. The gripping component 12 is—as indicated in FIG. 1 by the double arrow in the area of the handling device 8—mounted to be displaceable with several freedom degrees. The degrees of freedom of the gripper component 12 are translative and/or rotary freedom degrees. Combined movements of the gripper arm 12 are possible in at least two different freedom degrees, i.e. combined translatory and rotational movements. The gripper device 13 could also be implemented as a robot (industrial robot), which comprises several robot arms with at least one degree of freedom, whereby at least one robot arm comprises at least one gripper component 12 movable in at least one degree of freedom.

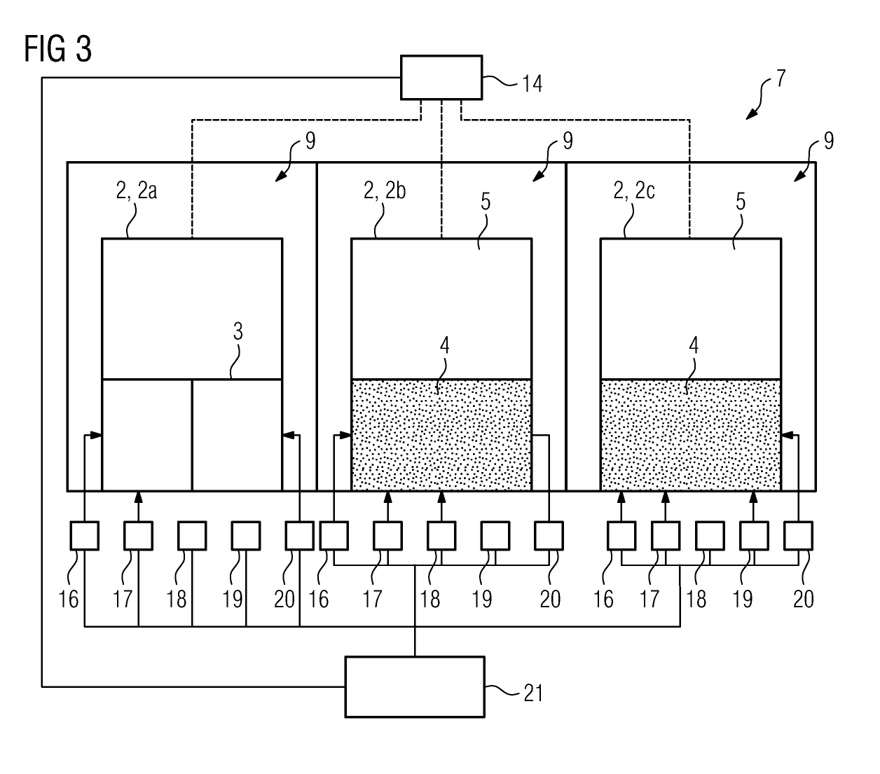

It can be seen from FIG. 3, which shows an exemplary detail of a storage device 7 in the form of a schematic diagram, that a recording device 14 can be associated with the respective storage partitions 9. The recording device 14 comprises recording elements (not shown) implemented by hardware and software, by means of which different recording parameters can be recorded. All recording parameters recorded by a corresponding recording device 14 can be transmitted via a possibly wireless data or communications network (not shown) to at least one communications partner, i.e. a central control device of a facility 15 for the generative manufacture of three-dimensional objects (cf. FIG. 4.).

The recording device 14 can in principle be configured for the recording of a functional unit 2 in a respective storage partition 9. With recording device 14 it is possible to detect if a functional unit is stored in a given storage partition 9. In the case of a functional unit 2 detected in a given storage partition 9, the type of functional unit 2 (for example, construction module 2a, dosing module 2b, overflow module 2c) specifically at hand can further be recorded. It can consequently be recorded which storage capacity of the storage device 7 is free or occupied and which functional unit(s) 2 are in which storage partitions 9. The recording of a functional unit of a specific kind in a given storage partition 9 can, for example, be carried out optically—that is, particularly, by means of an optical scanning process—or mechanically—that is, particularly, by means of recording the weight of the functional unit 2 acting on the storage device 7.

The or a (further) recording device 14 can, for example, be configured for the recording of at least one status parameter, particularly the functionality, of at least one functional element of a functional unit 2 located in the storage partition 9 in question. In the case of a construction module 2a it is, for example, ascertainable whether the proper functionality of the displaceably-mounted construction board 3 is correct. The recording device 14 can, for example, transmit appropriate control information to a drive connected to the displaceably-mounted construction board 3 and, for example, carry out a local and/or timed recording (monitoring) of a movement of the construction board 3 under the given actuator conditions by means of the control information. The recorded movement of the construction board 3 enables conclusions regarding the functionality of the displaceable mounting of the construction board 3.

The or a further recording device 14 can, for example, be configured for the recording of at least one, especially physical, status parameter within a recording space 5 having at least in part sections filled with construction material 4 of a functional unit 2 designated in the given storage partition 9. In the case of a dosing or overflow module 2b, 2c the atmosphere, pressure, humidity, temperature, etc. within the given recording space 5 can be recorded. The recorded status parameters inside a recording space 5 enable conclusions regarding the quality or processability or reusability of the construction material 4 in the functions unit 2. The recording of corresponding status parameters can be done by means of appropriate recording elements that are configured as a probe which record corresponding conditional parameters via an interface provided for this purpose. A functional interface on the side of the unit can, for example, be realized by means of an access point (not shown) on and/or in a recording space 5 for functional units.

The or a further recording device 14 can be configured for the recording of the fill level of a construction material 4, which is configured in a recording space 5 of a functional unit 2 in the storage partition 9. In the case of a dosing or overflow module 2b, 2c, the fill level is ascertainable within the recording space 5. The recorded fill levels enable conclusions as to the necessity of filling or emptying the dosing or overflow module 2b, 2c. The recording of corresponding fill levels can be done by means of appropriate recording elements that are configured as a probe which record corresponding fill levels via an interface provided for this purpose. An interface for functional units can, for example, also here be realized by means of an access point on and/or in a recording space 5 for functional units.

Finally, the or a further recording device 14 can, for example, be configured for the recording of one, particularly physical, status parameter of a construction material 4, which is configured in a recording space 5 of a functional unit 2 in the storage partition 9. In the case of a dosing or overflow module 2b, 2c, density, humidity, temperature, etc. are recorded for a construction material 4. The recorded status parameters inside a recording space 5 enable conclusions regarding the quality or processability or reusability of the construction material 4 in the functional unit 2. The recording of corresponding status parameters can be done by appropriate means, for example recorded elements from measuring probes, which record corresponding conditional parameters via an interface provided for this purpose. A functional interface on the side of the unit can, for example, be realized by means of an access point on and/or in a recording space 5 for functional units.

Depending on configured recording parameters via corresponding recording devices, the storage device 7 can comprise certain further devices—or at least be connected with them as regards data—by means of which certain measures can be taken independently of the acquisition parameters in order, for example, to influence the quality etc. of processability of the construction material 4 located in a functional unit of a recording space 5.

In the exemplary embodiment shown in FIG. 3 a tempering device 16 can be assigned to storage partition 9 that is configured for tempering at least one recording space 5 filled at least in sections of a functional unit 2 and/or for tempering a construction material 4 that is in a recording space 5 of a functional unit 2 of the storage partition 9. Tempering, which is typically understood to be heating, can, for example, be done by (direct) tempering of the functional unit 2 and/or by control (activation) of a functional unit of designated tempering agents (not shown), for example, heating elements. For tempering the functional unit 2, tempering device 16 can introduce a correspondingly tempered tempering fluid by means of a suitable connection device or interface, for example, in a functional unit of a tempering channel structure. For the control (activation) of tempering agents provided on the functional unit, the tempering device can transmit control data via a suitable connection device or interface, whereby a simple electric supply is understood, to the respective tempering agents of the functional unit.

Furthermore, an inerting device 17 can be assignable or assigned to at least one storage partition 9 that is configured for inerting at least one recording space 5 of a functional unit 2 in the given recording space 5 filled with construction material 4. The inerting device 17 for inerting a recording space 5 can via suitable means of connection or interfaces (not shown) and exhaust devices (not shown), and with these suction devices (not shown) connectable or connected to them exhaust non-inert gases or gas mixtures, such as air, from the recording space 5 and/or introduce with these connectable or connected fan devices (not shown) inert gases or gas mixtures such as argon, CO2, nitrogen, etc. into the recording space 5.

Furthermore, a filling device 18 is assigned to the storage partitions 9 that is configured for the filling of at least one recording space 5 of a functional unit 2 configured in the given recording space 5 filled with construction material 4 and an emptying device 19 that is configured for emptying construction material 4 located in at least one recording space 5 of a functional unit 2 in the storage partition 9. For the filling of a recording space 5, for example a recording space of a dosing module 2b, a filling device 18 can introduce construction material 4 into the recording space 5 via a filling device through suitable means of connection (not shown) or interfaces (not shown) with these connectable or connected handling devices. For emptying a recording space 5, for example a recording space 5 of an overflow module 2c, an emptying device 19 can siphon construction material 4 by means of appropriate connections or interfaces (not shown) from the recording space 5.

At least one security device 20 can be assigned to storage partitions 9 that is installed fixed in place for security of a functional unit 2 installed in a storage partition 9. A corresponding security device 20 enables fixed and stable mounting of a storage device of a functional unit 2 installed in a storage partition 9 and thus increases the security of the storage device 7. The security device 20 can comprise at least one—especially mechanical and/or magnetic—security element (not shown), for example in the form of a mechanical pin, projection, etc. or of a magnetizable or magnetic magnet element, which acts in a security circumstance on the functional unit 2 to be secured so that the functional unit 2 is installed fixed to its position in the storage partition 9. Corresponding especially mechanical or magnetic counter security elements (not shown), for example in the form of receiving magnetic security pins or magnetizable or magnetic magnet elements, can be provided.

The storage device 1 can comprise a control device 21, i.e. a tempering device 16, an inerting device 17, a filling device 18, an emptying device 19, or a security device 20 for control of the operation of the above-named devices. The control device 21 is especially configured to control the operation of individual, several, or all of the named devices. The control can be carried out on the basis of at least one recording parameter recorded by means of a recording device 14. Control of the operation of a tempering device 16 dependent on a recorded temperature of construction material 4 can, for example, be carried out in order to temper the construction material 4 accordingly. In a corresponding manner, control of an operation, for example of an inerting device 17 dependent on recorded atmosphere and/or recorded pressure within a recording space 5, can be carried out in order to inertize the recording space 5.

FIG. 4 shows a schematic diagram of a facility 15 for the generative manufacture of three-dimensional objects. The facility comprises at least one, possibly multiple, storage device(s) 1 as described for storage of modular functional units 2 used in the generative manufacture of three-dimensional objects such as at least one—that is, for example, in a given case, multiple—device(s) 6 for the generative manufacture of three-dimensional objects through successive layered selective solidification of construction material layers from solidifiable construction material 4 by means of at least one energy or laser beam. The latter devices 6 comprise at least one device for generation of at least one energy or laser beam (not shown) for layered selective solidification of individual construction material layers from solidifiable construction material 4. For the latter devices 6 it may be a matter of selective laser melt devices (SLM devices) or selective laser sinter devices (SLS devices).

It is possible that the arrangement or integration of the storage device 7 inside the facility 15—as shown in FIG. 4—is located upstream or downstream from a device for generative manufacture of three-dimensional objects. Specifically, a storage device 1 can be upstream or downstream, for example, of a preparation station 22 (handling station) for preparation of a generative construction process or of a reprocessing station 23 (handling or unpacking station) for post-processing a generative construction process, that is, especially, for “unpacking” a generatively manufactured three-dimensional object.

To the extent that the facility 15 comprises several separate storage devices 1, transport devices (not shown)—that is, for example, in a given case, inertable tunnel-like transport systems 24—can be provided in order to transport functional units 2 back and forth between separated storage devices 1.

### REFERENCE NUMBER LIST

1 Storage device

2 Functional unit

2a Construction module

2b Dosing module

2c Overflow module

3 Building plate

4 Construction material

5 Recording space

6 Device

7 Storage device

8 Handling device

9 Storage partition

10 Shelf element

11 Wall

12 Gripper component

13 Gripper device

14 Recording device

15 Facility

16 Tempering device

17 Inerting device

18 Filling device

19 Emptying device

20 Security device

21 Control device

22 Preparation station

23 Post-processing station

24 Transport system

1. A device (1) for storage of modular functional units (2) to be used in the context of the generative production of three-dimensional objects, characterized by
a storage device (7) with several storage partitions (9) which are configured for storage of at least one functional unit (2) of a modular type, and
a handling device (8) assignable or assigned to the storage device (7) for the handling of at least one modular functional unit (2), which is configured for application of at least one modular functional unit (2) in a given storage partition (9) and/or for removal of at least one modular functional unit (2) in a given storage partition (9) from this or any other given storage partition (9).

2. A device according to claim 1, characterized in that the handling device (8) is configured as one gripping device (13) or at least comprises such a device including a handling or gripping component (12).

3. A device according to claim 1, characterized in that the storage device (7) comprises a shelf-like construction with storage partitions (9) arranged or configured in different rows and/or columns.

4. A device according to claim 1, characterized in that there is
a functional unit (2) configured as a construction module (2a) comprising a building board (2) that is movable, specifically height-adjustable, relative to a base body of the construction module (2a), and on which building board generative construction of a three-dimensional object is carried out, or
a functional unit (2) is configured as an overflow module (2b) comprising a typically chamber-like recording space (5) configured for the recording of non-solidified construction material (4) in the context of the generative manufacture of a three-dimensional object, or
a functional unit (2) is configured as a dosing module (2c) comprising at least one typically chamber-like recording space (5) configured for the recording of construction material (4) to be solidified in the generative manufacture of a three-dimensional object and, a dosing device for dosing a given amount of construction material (4), which is to be solidified, from the recording space (5).

5. A device according to claim 1, characterized in that at least one recording device (14) is assignable to or assigned to a storage partition (9), which is configured
for the recording of a functional unit (2) in the storage partition (9) in question and/or
for the recording of at least one status parameter, particularly the functionality, of at least one functional element of a functional unit (2) located in the storage partition (9) in question and/or
for the recording of at least one, especially physical, status parameter within a recording space (5) having at least in part sections filled with construction material (4) of a functional unit (2) designated in the given storage partition (9) and/or
for the recording of the fill level of a construction material (4), which is received in a recording space (5) of a functional unit (2) located in the storage partition (9) in question and/or
for the recording of at least one status parameter of a construction material (4), which is received in a recording space (5) of a functional unit (2) in the respective storage partition (9).

6. A device according to claim 1, characterized in that a tempering device (16) can be assignable or is assigned to at least one storage partition (9) and is configured for tempering at least one recording space (5) of a functional unit (2) in the given storage partition (9), filled with construction material (4), in particular at least in sections, and/or for tempering a construction material (4) that is in a recording space (5) of a functional unit (2) of the storage partition (9).

7. A device according to claim 1, characterized in that an inerting device (17) can be assignable or is assigned to at least one storage partition (9) and is configured for inertizing at least one recording space (5) filled with construction material (4), in particular at least in sections, in a functional unit (2) of the respective storage partition (9).

8. A device according to claim 1, characterized in that at least one filling device (18) can be assignable or is assigned to at least one storage partition (9) and is configured for the filling of at least one recording space (5) of a functional unit (2) of the respective storage partition (9) with construction material (4), and/or at least one emptying device (19) assignable or assigned to a storage partition (9) that is configured for emptying of construction material (4) located in at least one recording space (5) of a functional unit (2) in the respective storage partition (9).

9. A device according to claim 1, characterized in that at least one security device (20) can be assignable or is assigned to at least one storage partition (9) and is configured for security fixed in position of at least one functional unit (2) in a storage partition (9), whereby the security device (20) comprises at least one especially mechanically or magnetically operating security element.

10. A device according to claim 1, characterized by a control device (21) for the control of the tempering device (16) and/or the inerting device (17) and/or the filling device (18) and/or the emptying device (19) and/or the security device (20) depending of at least one of the recording results of the recording device (14).

11. A device according to claim 1, characterized in that single, several, or all storage partitions (9) are spatially defined by walls (11), whereby at least one wall (11) is displaceable relative to at least a further wall (11), so that a storage partition (9), spatially limited in its dimensions, is alterable by the minimum one displaceable wall (11) and at least a further wall (11) through movement of at least one displaceably-mounted wall (11) relative to at least a further wall (11).

12. A facility (15) for the generative manufacture of three-dimensional objects comprising:
at least one device (1) for the storage of modular functional units (2) to be used in the context of the generative production of three-dimensional objects according to claim 1,
at least one device (6) for the generative manufacture of three-dimensional objects by successive layered selective solidification of construction material layers from solidifiable construction material (4) by means of at least one energy beam including at least one device for generating at least one energy beam for layered selective solidification of individual construction material layers from solidifiable construction material (4).

13. A facility according to claim 12, characterized in that at least one device (1) for storage of modular functional units (2) of at least one device (6) used in the context of the generative manufacture of three-dimensional objects is applied upstream or downstream.

14. A facility according to claim 12, characterized in that it comprises several separate devices (1), whereby in a given case inertable transport devices are provided between separate devices (1), so that functional units (2) can be transported back and forth between separate devices (1).
